(19) United States
(12) Patent Application Publication
(10) Pub. No.: US 2015/0291479 A1
(43) Pub. Date: Oct. 15, 2015

(54) PCBN COMPOSITES AND METHODS OF MAKING THE SAME

(71) Applicant: Smith International, Inc., Houston, TX (US)

(72) Inventors: Xian Yao, Sandy, UT (US); John Daniel Belnap, Lindon, UT (US)

(21) Appl. No.: 14/683,477

(22) Filed: Apr. 10, 2015

Related U.S. Application Data
(60) Provisional application No. 61/978,779, filed on Apr. 11, 2014.

(51) Int. Cl. C04B 35/5831

(52) U.S. Cl. CPC C04B 35/5831

(57) ABSTRACT

Polycrystalline cubic boron nitride includes cubic boron nitride grains and AlB₁₂ between the cubic boron nitride grains. A method of manufacturing heat-treated polycrystalline cubic boron nitride includes sintering a mixture including cubic boron nitride and aluminum metal powder to form polycrystalline cubic boron nitride, and heat-treating the polycrystalline cubic boron nitride to form the heat-treated polycrystalline cubic boron nitride. A method of manufacturing polycrystalline cubic boron nitride includes sintering a mixture including cubic boron nitride and aluminum metal powder, the mixture including the cubic boron nitride in an amount of 85 vol % to 95 vol % and the aluminum metal powder in an amount of 5 vol % to 15 vol %, based on the total volume of the mixture.

### CROSS REFERENCE TO RELATED APPLICATIONS

This application claims the benefit to and priority of U.S. Provisional Application No. 61/978,779, filed on Apr. 11, 2014, which is hereby incorporated by reference in its entirety.

### BACKGROUND

Polycrystalline cubic boron nitride (PCBN) composite materials may be formed by high-pressure high-temperature (HPHT) sintering of a mixture including cubic boron nitride (cBN) crystals as a hard (or strong) phase (e.g., an ultra-hard material), and aluminum (Al) metal powder, which becomes a liquid sintering reactant. PCBN may be used in a variety of machining applications including, for example, in tools for friction stir welding, processing, or joining A tool used for friction stir welding may include a strong pin including PCBN that is moved along a joint between two pieces of material to super-plastically deform a portion of each piece of material and weld the two pieces together.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to embodiments of the disclosed subject matter, polycrystalline cubic boron nitride includes cubic boron nitride grains and AlB₁₂ between the cubic boron nitride grains. According to other embodiments of the disclosed subject matter, a method of manufacturing heat-treated polycrystalline cubic boron nitride includes sintering a mixture including cubic boron nitride and aluminum metal powder to form polycrystalline cubic boron nitride, and heat-treating the polycrystalline cubic boron nitride to form the heat-treated polycrystalline cubic boron nitride. According to still other embodiments of the disclosed subject matter, a method of manufacturing polycrystalline cubic boron nitride includes sintering a mixture including cubic boron nitride and aluminum metal powder, the mixture including the cubic boron nitride in an amount of 85 vol % to 95 vol % and the aluminum metal powder in an amount of 5 vol % to 15 vol %, based on the total volume of the mixture.

### BRIEF DESCRIPTION OF THE DRAWINGS

The accompanying drawings, together with the specification, illustrate example embodiments of the disclosed subject matter, and, together with the description, serve to explain principles of the disclosed subject matter.

FIG. 1 is a phase diagram of a system including aluminum and boron.

FIG. 2 is a schematic perspective view of an embodiment of a friction stir welding tool joining two workpieces together.

FIG. 3 is a schematic cross-sectional view of the embodiment of the friction stir welding tool shown in FIG. 2 joining two workpieces together.

FIG. 4 is a schematic cross-sectional view of an embodiment of a cutting tool.

FIG. 5 is an X-ray diffraction spectrum of a friction stir welding tool according to a comparative example.

FIG. 6 is an X-ray diffraction spectrum of a friction stir welding tool according to a comparative example.

FIGS. 7 to 10 are photographs of a friction stir welding tool according to a comparative example.

FIG. 11 is a chart showing transverse rupture strength of PCBN bars according to a comparative example and embodiments of the present disclosure.

FIG. 12 is a chart showing transverse rupture strength of PCBN bars according to embodiments of the present disclosure.

FIG. 13 is a chart showing transverse rupture strength of PCBN bars according to a comparative example and embodiments of the present disclosure.

FIG. 14 is an X-ray diffraction spectrum of a PCBN bar according to an embodiment of the present disclosure.

FIG. 15 is a scanning electron microscope photograph and energy dispersive X-ray spectrum of a PCBN bar according an embodiment of the present disclosure.

FIG. 16 is a scanning electron microscope photograph of a PCBN bar according to an embodiment of the present disclosure.

FIG. 17 is a chart showing fracture toughness (K_{IC}) of PCBN bars according to a comparative example and embodiments of the present disclosure.

FIGS. 18 and 19 are scanning electron microscope photographs of a PCBN bar according to an embodiment of the present disclosure.

FIG. 20 is a scanning electron microscope photograph of a PCBN bar according to a comparative example.

FIG. 21 is chart showing thermogravimetric analysis of PCBN bars according to embodiments of the present disclosure.

FIG. 22 is a chart showing fracture toughness (K_{IC}) of PCBN bars according to embodiments of the present disclosure.

FIGS. 23 and 24 are scanning electron microscope photographs of PCBN bars according to embodiments of the present disclosure.

FIG. 25 is a chart showing transverse rupture strength of PCBN bars according to embodiments of the present disclosure.

FIG. 26 is a chart showing fracture toughness (K_{IC}) of PCBN bars according to embodiments of the present disclosure.

FIG. 27 is a series of photographs of a fractured friction stir welding tool according to an embodiment of the present disclosure.

FIG. 28 is a pair of scanning electron microscope photographs of a fractured surface of a friction stir welding tool according to an embodiment of the present disclosure.

FIGS. 29 and 30 are X-ray diffraction spectra of PCBN bars according to embodiments of the present disclosure.

FIG. 31 is a schematic view of a diametral compression sample and apparatus for conducting a fracture toughness test.

FIG. 32 is a photograph of a disk undergoing a fracture toughness test according to the diametral compression method.

### DETAILED DESCRIPTION

In the following detailed description, only certain example embodiments of the disclosed subject matter are shown and described, by way of illustration. As those skilled in the art would recognize, the disclosed subject matter may be embodied in many different forms and should not be construed as being limited to the embodiments set forth herein. Also, in the context of the present disclosure, when a first element is referred to as being “on” a second element, it may be directly on the second element or be indirectly on the second element with one or more intervening elements therebetween. Like reference numerals designate like elements throughout the specification.

According to embodiments of the present disclosure, polycrystalline cubic boron nitride (PCBN) includes cubic boron nitride (cBN) grains and AlB₁₂ between the cubic boron nitride grains. The PCBN may further include AlN. An amount of the AlB₁₂ may be greater than an amount of AlB₂ in the PCBN, which may include AlB₂ in detectable amounts or may be substantially or completely free of AlB₂. Although the present disclosure is not limited by any particular mechanism or theory, it is believed that when an article (e.g., a friction stir welding tool) including PCBN free of AlB₁₂ and including AlB₂ is placed under high thermo-mechanical load conditions and temperatures of 980° C. or higher (e.g., under conditions present during friction stir welding), the AlB₂ decomposes (or partially decomposes) and releases aluminum metal (e.g., liquid aluminum metal), which may lead to cBN grain boundary attack and may lead to premature cracking of the article.

For example, it is believed that grain boundary attack resulting from the decomposition (or partial decomposition) of AlB₂, and the accompanying release of aluminum metal, is a substantial cause of premature cracking in PCBN friction stir welding tools used for the processing of stainless steel or hardened steel. Thus, some embodiments of the present disclosure are directed toward PCBN having a reduced amount of AlB₂ (e.g., an amount of AlB₂ that is less than that of AlB₁₂). Embodiments of the PCBN that include a reduced amount of AlB₂ (e.g., include AlB₁₂ in an amount greater than that of AlB₂, which may be zero or close to zero) exhibit increased density, hardness, flexural strength, fracture toughness, and/or high temperature thermostability as compared to PCBN that does not include a reduced amount of AlB₂ and/or does not include AlB₁₂.

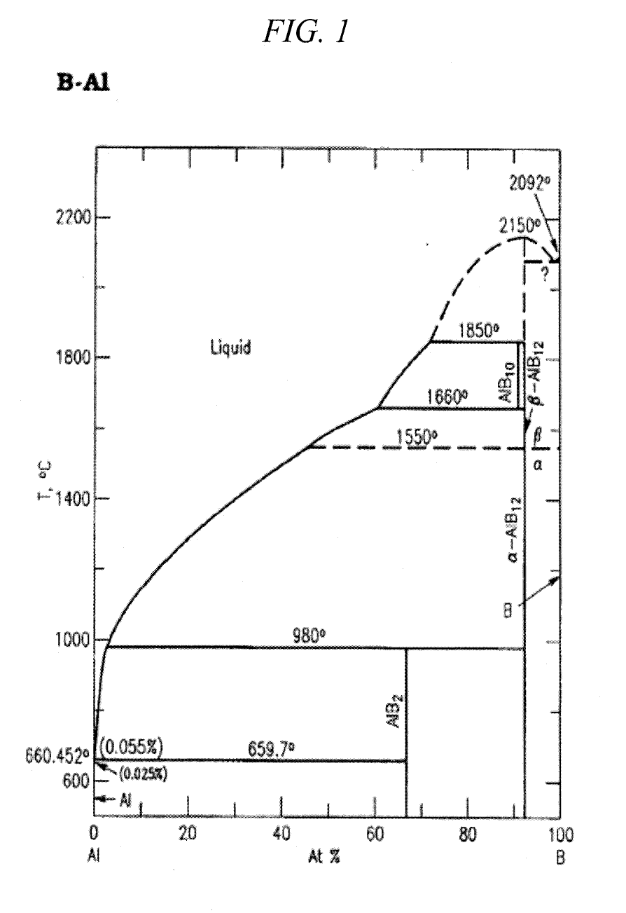

FIG. 1 is a graph illustrating a phase diagram of a system including boron and aluminum at atmospheric pressure. As can be seen in FIG. 1, under certain conditions (e.g., depending upon temperature and boron to aluminum ratio), the system can include AlB₂ and/or AlB₁₂. For example, at a temperature less than or equal to 980° C. and a boron to aluminum ratio less than 12:1, boron and aluminum may react with each other to form AlB₂ as shown in Reaction Scheme 1 below. On the other hand, at a temperature greater than or equal to 980° C. and a boron to aluminum ratio of 12:1 or higher, boron and aluminum may react with each other to form AlB₁₂ as shown in Reaction Scheme 2 below.

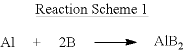

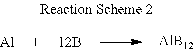

As can be seen in the phase diagram of FIG. 1, AlB₁₂ has a decomposition temperature of about 1550° C., which is much higher than that of AlB₂, which is about 980° C. At atmospheric pressure and temperatures at or greater than 980° C., AlB₂ may decompose to liquid aluminum and AlB₁₂ according to Reaction Scheme 3 below.

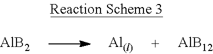

It is believed that, under the thermo-mechanical load conditions present during friction stir welding, the formation of aluminum metal (e.g., as a liquid) from the decomposition of AlB₂ in PCBN according to Reaction Scheme 3 may lead to cBN grain boundary attack and may lead to premature cracking of an article including the PCBN. For example, when the decomposition occurs under the conditions present during friction stir welding, the aluminum metal may weaken the adhesion of the cBN grains to one another, which may weaken the PCBN and lead to premature cracking.

It is further believed that, in the absence (or substantial absence) of a mechanical load, heating PCBN at a temperature of 980° C. or greater strengthens the PCBN by the decomposition of existing AlB₂ to AlB₁₂ and aluminum metal, which may further react to form, for example, AlN. Thus, according to embodiments of the present disclosure, reducing the amount of AlB₂ in PCBN, or replacing AlB₂ in PCBN with AlB₁₂, improves the mechanical properties of the PCBN (e.g., mechanical properties such as density, hardness, flexural strength, fracture toughness, and/or high temperature thermostability).

According to embodiments of the present disclosure, PCBN including AlB₁₂ (e.g., PCBN including a reduced amount of AlB₂) can be prepared by controlling amounts of aluminum and boron in a mixture used to prepare the PCBN, by controlling a surface area of cBN particles in the mixture, by increasing a temperature for sintering the PCBN, and/or by heat-treating sintered PCBN, which may include AlB₂ (e.g., in a small amount). For example, a ratio of aluminum to boron in a mixture (e.g., a sintering mixture) used to prepare PCBN may be controlled such that the PCBN includes AlB₁₂ (e.g., the amount of AlB₁₂ in the resultant PCBN is greater than that of AlB₂), but the present disclosure is not limited thereto. Increasing the ratio of Al to B in the mixture favors the formation of AlB₂ over the formation of AlB₁₂, while decreasing the ratio of Al to B in the mixture favors the formation of AlB₁₂ over the formation of AlB₂. Reducing the amount of the Al in the mixture too much, however, may lead to undesirably low (or insufficient) densification and/or increased porosity of the resultant PCBN and diminish the mechanical properties of the PCBN.

For example, decreasing the ratio of Al to B may decrease the distance between cBN particles in the mixture and may decrease the mean free path for Al to reach and wet the surface of the cBN. While the present disclosure is not limited by any mechanism or theory, it is believed that decreasing the mean free path for Al to reach and wet the surface of the cBN according to embodiments of the present disclosure may increase an amount of reaction between aluminum and boron, and increase the amount of AlB₁₂ formed. On the other hand, increasing the ratio of Al to B may increase the distance between cBN particles in the mixture and may increase the mean free path for aluminum to reach and wet the surface of the cBN. Thus, it is believed that increasing the mean free path for aluminum to reach and wet the surface of the cBN may decrease an amount of reaction between aluminum and boron, and increase the amount of AlB₂ formed.

The ratio of aluminum to boron in the mixture used to prepare the PCBN may be 1:3 to 1:12, or, for example, 1:10, but the present disclosure is not limited thereto. The aluminum in the mixture may be present in the form of, for example, aluminum powder, AlB₂, AlN, compounds or alloys of aluminum and carbon, calcium, cobalt, nickel, titanium, silicon, magnesium, and/or zirconium, and mixtures thereof, but the present disclosure is not limited thereto. The boron in the mixture may be present in the form of cBN, elemental boron, hexagonal boron nitride (hBN), boron carbide (B₄C), boron oxide (e.g., B₂O₃), compounds or alloys of boron and titanium, cobalt and/or nickel, and mixtures thereof, but the present disclosure is not limited thereto. Under sintering conditions (e.g., a pressure higher than 5 GPa and a temperature of 1200° C. or higher), the aluminum liquefies and reacts with the cBN. For example, a portion of the aluminum reacts with nitrogen of the cBN to form AlN, and another portion of the aluminum reacts with boron of the cBN to form AlB₁₂. In some embodiments, still another portion of the aluminum reacts with boron of the cBN to form AlB₂. Aluminum that is adjacent to, or in direct contact with, a source of boron (e.g., cBN) forms AlB₁₂ at T≧980° C. as a result of the abundant supply of boron atoms available to react with the aluminum. On the other hand, aluminum that is further away from the source of boron will have fewer boron atoms with which to react and, thus, may form AlB₂, even at temperatures higher than 980° C. For example, once the aluminum that is adjacent to, or in direct contact with, a source of boron (e.g., cBN) forms AlB₁₂ (or AlN), the remaining aluminum has less opportunity to react with boron atoms and, thus, may form AlB₂.

In some embodiments, a method of manufacturing PCBN includes sintering a mixture (a sintering mixture) including cBN and aluminum metal powder, the mixture including the cBN in an amount of 70 volume percent (vol %) to 95 vol % and the aluminum metal powder in an amount of 5 vol % to 30 vol %, based on the total volume of the mixture. For example, the mixture may include the cBN in an amount of 80 volume percent (vol %) to 95 vol % and the aluminum metal powder in an amount of 5 vol % to 20 vol %, based on the total volume of the mixture. The PCBN may include AlB₁₂ (e.g., the PCBN may include AlB₁₂ in an amount greater than that of AlB₂). The amount of the cBN in the mixture may be 85 vol % to 95 vol %, 87 vol % to 93 vol %, 89 vol % to 91 vol %, or 90 vol %, based on the total volume of the mixture, but the present disclosure is not limited thereto. The amount of the aluminum in the mixture may be 5 vol % to 15 vol %, 7 vol % to 13 vol %, 9 vol % to 11 vol %, or 10 vol %, based on the total volume of the mixture, but the present disclosure is not limited thereto. By including cBN and aluminum in the mixture in any of the foregoing amounts, PCBN including AlB₁₂ (e.g., PCBN including AlB₁₂ in an amount greater than that of AlB₂) may be prepared. Preparing PCBN from a mixture including cBN in an amount of 85 vol % to 95 vol %, and aluminum (e.g., aluminum powder) in an amount of 5 vol % to 15 vol %, may not, on its own, however, be sufficient to ensure that the resultant PCBN includes AlB₁₂ (e.g., includes AlB₁₂ in an amount greater than that of AlB₂) and has improved mechanical properties such as density, hardness, flexural strength, fracture toughness, and/or high temperature thermostability. On the other hand, sintering a mixture including cBN and aluminum in amounts of 80 vol % cBN and 20 vol % aluminum may, without further processing or treatment, provide PCBN that includes AlB₂ and does not include AlB₁₂.

The surface area (e.g., total surface area) of the cBN particles in the mixture used to prepare the PCBN may also affect the presence of AlB₁₂ in the resultant PCBN, and may affect the resultant ratio of AlB₁₂ to AlB₂. The surface area of the cBN particles in the mixture can be controlled by controlling the particle size of the cBN particles. For example, while the present disclosure is not limited by any particular mechanism or theory, it is believed that decreasing the particle size of the cBN particles in the mixture increases the amount of surface area of cBN available to react with aluminum, which increases the amount of boron available for fast and in situ reactions with aluminum. Thus, it is believed that decreasing the particle size of the cBN particles favors the formation of AlB₁₂ over the formation of AlB₂. On the other hand, it is believed that increasing the particle size of the cBN particles in the mixture may decrease an amount of surface area of cBN available to react with aluminum, which may decrease the amount of boron available to react with aluminum and increase the cBN-cBN mean free path for aluminum to reach and wet the cBN surfaces. Thus, it is believed that increasing the particle size of the cBN particles in the mixture favors the formation of AlB₂ over the formation of AlB₁₂.

For example, sintering a mixture including cBN particles having a particle size distribution (e.g., a single modal particle size distribution) having a D₅₀ of 12 to 22 μm, may, under certain conditions, provide PCBN including mostly AlB₂ (e.g., PCBN including AlB₂ in an amount greater than that of AlB₁₂). Adding cBN particles having a relatively smaller particle size to the mixture increases the cBN surface area available to react with aluminum and may allow for PCBN including AlB₁₂ in an amount greater than that of AlB₂ to be prepared.

In some embodiments, the mixture includes cBN particles having a particle size of 0.5 to 4 μm, or 2 to 4 μm, but the present disclosure is not limited thereto. For example, the mixture may include a bimodal particle size distribution of cBN particles including first cBN particles and second cBN particles, the first cBN particles having a particle size larger than that of the second cBN particles. The relatively larger cBN particles (e.g., the first cBN particles) provide the resultant PCBN with suitable hardness, fracture toughness, and abrasion resistance, while the relatively smaller cBN particles (e.g., the second cBN particles) may increase the cBN surface area available to react with aluminum and may increase the formation of AlB₁₂ relative to the formation of AlB₂.

The mixture may include cBN particles (e.g., the first cBN particles) having a particle size (e.g., a first particle size) of 12 to 22 μm in an amount of 70 vol % to 90 vol %, 75 vol % to 85 vol %, or, for example, 81 vol %, but the present disclosure is not limited thereto. In some embodiments, the cBN particles (e.g., the first cBN particles) have an average particle size of 10 to 15 μm. The mixture may further include cBN particles (e.g., the second cBN particles) having a particle size of 2 to 4 μm in an amount of 2 vol % to 15 vol %, 5 vol % to 10 vol %, or, for example, 9 vol %, but the present disclosure is not limited thereto. In some embodiments, the cBN particles (e.g., the second cBN particles) have a particle size of 0.5 to 3 μm.

When included in any of the foregoing amounts and particle sizes, the cBN in the mixture may have a sufficient amount of cBN surface area to increase the formation of AlB₁₂, or favor the formation of AlB₁₂ over the formation of AlB₂, while having an amount of the relatively larger cBN particles sufficient to provide PCBN having suitable hardness, fracture toughness and abrasion resistance. For example, adding 9 vol % of cBN particles having a particle size of 2 to 4 μm to a mixture including 81 vol % of cBN particles having a particle size of 12 to 22 μm increases the cBN surface area of the mixture by as much as 50%. Thus, adding a small amount of the second cBN particles having a particle size relatively smaller than that of the first cBN particles to the mixture can increase the reactive surface area of the cBN, while maintaining a sufficient amount of the relatively larger first cBN particles to provide PCBN having suitable hardness, fracture toughness and abrasion resistance.

By including cBN particles having a particle size within any of the foregoing ranges in the mixture, PCBN including AlB₁₂ (e.g., PCBN including AlB₁₂ in an amount greater than that of AlB₂) may be prepared. Preparing PCBN from a mixture including cBN in amounts and particle sizes within the foregoing ranges may not, on its own, however, be sufficient to ensure that the resultant PCBN includes AlB₁₂ (e.g., includes AlB₁₂ in an amount greater than that of AlB₂) and has improved mechanical properties such as density, hardness, flexural strength, fracture toughness, and/or high temperature thermostability.

As can be seen in FIG. 1, under certain conditions, the reaction of aluminum and boron at temperatures at 980° C. or lower favors the formation of AlB₂ over the formation of AlB₁₂. According to embodiments of the present disclosure, the PCBN is prepared by sintering the mixture at a temperature of 980° C. or higher. Sintering at a temperature at or above 980° C., may not, on its own, however, be sufficient to prepare PCBN including AlB₁₂ (e.g., AlB₁₂ in an amount greater than that of AlB₂) and having improved mechanical properties such as density, hardness, flexural strength, fracture toughness, and/or high temperature thermostability.

In any of the embodiments described herein, the PCBN may be prepared using equipment and conditions generally used for the formation of PCBN. For example, the PCBN may prepared using any suitable press (e.g., a high-pressure high-temperature (HPHT) press), such as a cubic press, a belt press, a toroid press, or a multi-anvil press, but the present disclosure is not limited thereto. The PCBN may be prepared using pressures of 5 to 8 GPa (e.g., at a pressure greater than 5.5 GPa), temperatures of 1200° C. to 1500° C., and sintering times of 2 to 30 minutes, but the present disclosure is not limited thereto.

According to additional embodiments of the present disclosure, a method of manufacturing heat-treated PCBN includes sintering a mixture including cubic boron nitride and aluminum metal powder to form PCBN, and heat-treating the HPHT sintered PCBN to form the heat-treated PCBN. The heat-treated PCBN may include AlB₁₂ (e.g., include AlB₁₂ in an amount greater than that of AlB₂). The mixture may be sintered according to any of the embodiments described herein or according to any process generally used in the art. The heat-treating may be carried out at a temperature of 900° C. to 1300° C., 950° C. to 1300° C., 980° C. (or higher than 980° C.) to 1200° C., or 1000° C. to 1200° C. The heat-treating may be performed for any suitable time period. For example, the heat-treating may be performed for 5 minutes to 120 minutes, or 60 minutes to 90 minutes. According to embodiments of the present disclosure, the heat-treating is performed in the absence (or substantial absence) of a load being placed upon the PCBN. For example, according to embodiments of the present disclosure, heating that occurs during use of an article including PCBN (such as heating that occurs during use of a friction stir welding tool including PCBN) is not equivalent to embodiments of the heat-treating described herein. The heat-treating may be performed at any suitable pressure, from vacuum (e.g., 10⁻² to 10⁻⁹ Torr) up to 2 times atmospheric pressure (e.g., 1520 Torr). The pressure (or vacuum) may be controlled by positively charging or the flow-through of inert gases (e.g., He, Ne, and/or Ar), N₂, H₂, NH₃, or a mixture of such gases, which can prevent or reduce the oxidation of cBN, AlN, AlB₁₂, and/or AlB₂ at the heat-treating temperature. The heat for the heat-treating may be supplied by any suitable apparatus. The heat-treating may be performed using any suitable form of heating, such as, for example, conduction, convection, radiation (e.g., infrared radiation), or a combination thereof. For example, the heat-treating may include heating the PCBN with a heating element (e.g., a heating element of a furnace).

According to any of the embodiments of the present disclosure, the AlB₁₂ may be present in the PCBN (or heat-treated PCBN) in an amount of 0.5 wt % to 10 wt %, 0.5 wt % to 5 wt %, or a non-detectable amount (e.g., an amount that is not detectable by measurement techniques such as X-ray diffraction), based on the total weight of the PCBN (or heat-treated PCBN). Further, according to any of the embodiments of the present disclosure, the AlB₂ may be present in the PCBN in an amount of 0 wt % to 10 wt %, or 0 wt % to 0.5 wt %, based on the total weight of the PCBN. For example, the PCBN may be substantially free of AlB₂, but the PCBN is not limited thereto. As used herein, the expression “substantially free of AlB₂” refers to PCBN that includes AlB₂ in an amount that is below the level of detection of measurement techniques such as X-ray diffraction (XRD) and/or in an amount that does not decrease the density, hardness, flexural strength, fracture toughness, and/or thermostability of the PCBN. While measurement techniques such as XRD may not be able to detect AlB₂ in PCBN that is substantially free of AlB₂, some non-negligible amount of AlB₂ (e.g., a non-detectable amount) may still be present in PCBN that is substantially free of AlB₂.

In some embodiments, the PCBN includes a reaction product of aluminum and boron, and the reaction product of aluminum and boron consists essentially of AlB₁₂, but the PCBN is not limited thereto. In this context, the expression “the reaction product of aluminum and boron consists essentially of AlB₁₂” means that any additional reaction products of aluminum and boron in the PCBN are present in amounts that will not materially decrease the density, hardness, flexural strength, fracture toughness, and/or thermostability of the PCBN. In some embodiments, the reaction product of aluminum and boron consists of AlB₁₂, and the PCBN does not include any other reaction products of aluminum and boron. For example, in some embodiments, the PCBN is completely free of AlB₂.

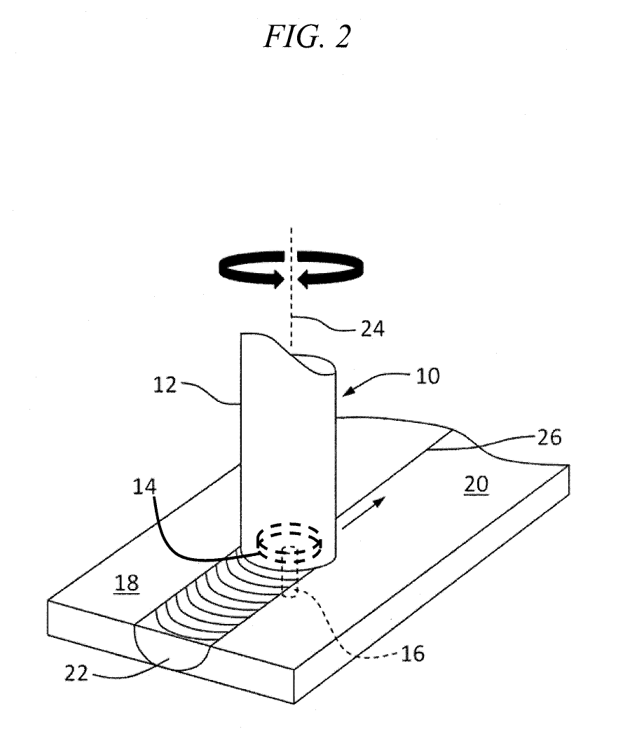

According to embodiments of the present disclosure, an article may include the PCBN (e.g., the heat-treated PCBN). The article may include various tools or blanks for forming the tools. For example, a friction stir welding tool may include the PCBN. An example embodiment of a friction stir welding tool 10 is shown in FIG. 2, but the present disclosure is not limited thereto. As shown in FIG. 2, the friction stir welding tool 10 includes a spindle 12 having a shoulder 14, and a pin 16, which penetrates the materials to be joined and performs the “stirring.” The shoulder 14 can also “stir” the materials to be joined. The friction stir welding tool rotates in one direction about an axis 24, but, as shown in FIG. 2, the friction stir welding tool can be configured to rotate in either direction. By rotating about the axis 24, the friction stir welding tool 10 mechanically joins two workpieces 18 and 20 by plastically deforming and mixing the materials being joined at sub-melting temperatures. The workpieces 18 and 20 (e.g., metallic materials) have respective edges aligned at interface 26.

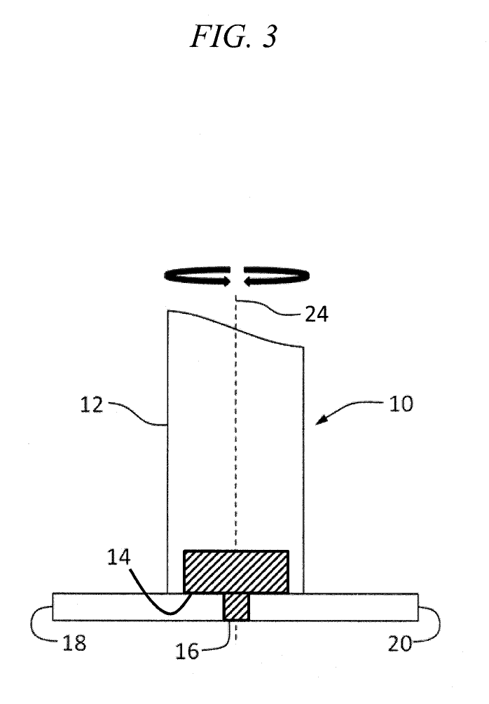

As shown in FIG. 2 and the cross-sectional view shown in FIG. 3, the pin 16 can penetrate into the two workpieces 18 and 20 (e.g., metal pieces) with the shoulder 14 contacting surfaces of the workpieces 18 and 20. The friction stir welding tool 10 is driven to rotate by the spindle 12, thereby “stirring” the materials to be joined. Rotating the friction stir welding tool 10 generates heat as a result of friction between the pin 16 and the workpieces 18 and 20, and between the shoulder 14 and the workpieces 18 and 20. A force directed toward the workpieces 18 and 20 (e.g., a downward force) can be applied to the friction stir welding tool 10 to maintain pressure and to facilitate the production of heat through friction. The heat generated by the friction stir welding tool 10 causes a portion of each of the workpieces 18 and 20 to be plastically deformed and joined. As the friction stir welding tool 10 travels along the interface 26, a weld 22 is formed between the workpieces 18 and 20.

In some embodiments, a method of manufacturing the friction stir welding tool includes machining the article (e.g., a blank) including the PCBN to form the friction stir welding tool. The method may further include heat-treating the friction stir welding tool at a temperature of 980° C. to 1200° C. (or 1000° C. to 1100° C.). In some embodiments, the method includes heat-treating the article (e.g., the blank) at a temperature of 980° C. to 1200° C. (or 1000° C. to 1100° C.) before the machining of the article.

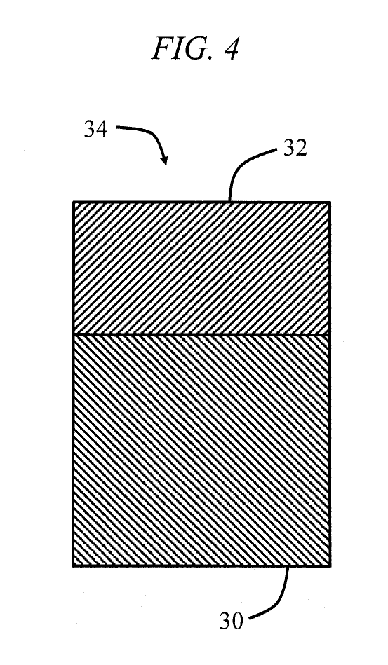

Tools other than friction stir welding tools can also be formed according to embodiments of the present disclosure. For example, embodiments of the present disclosure can be used to form a cutting tool as shown in FIG. 4. As shown in FIG. 4, the PCBN can be on a substrate 30 (e.g., tungsten carbide) to form a cutting layer 32 of a cutting element 34. For example, the PCBN (e.g., the heat-treated PCBN) can be bonded (e.g., welded or brazed) to the substrate after the composite material has been sintered. In another embodiment, prior to sintering, the mixture and the substrate can be placed in a capsule together and sintered, thereby forming the PCBN material bonded to the substrate. In any of the above embodiments, the PCBN can be heat-treated before or after being bonded to the substrate, or the heat-treatment can be omitted.

Embodiments of the present disclosure are further described below with reference to the following examples. The following examples, however, are not intended to limit the scope of the present disclosure.

### Preparation Example 1

A PCBN compact cylinder was prepared by sintering a mixture including 80 vol % cubic boron nitride and 20 vol % aluminum metal powder, based on the total volume of the mixture, in a cubic press at a pressure of higher than 5 GPa and a temperature of 1300° C. for a time period of 20 minutes. The cBN had a single modal particle size distribution in a range of 12 to 22 μm. The PCBN cylinder had a length of 1 inch (25.4 mm), and a diameter of 1 inch (25.4 mm).

### Comparative Example 1

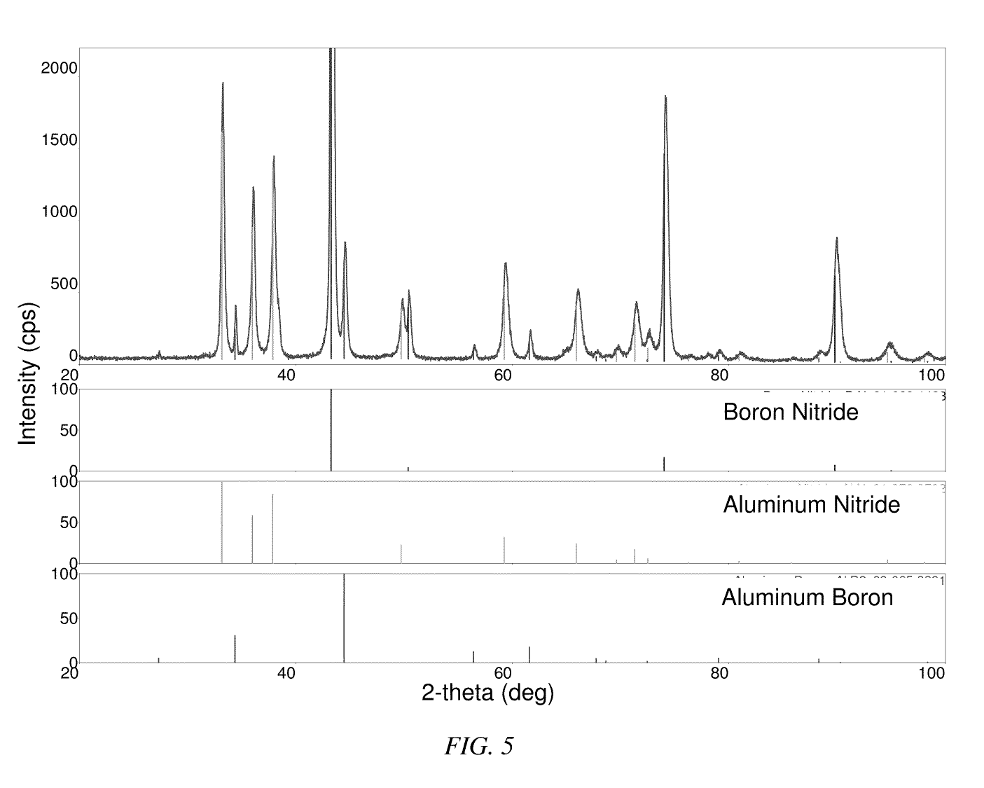

A PCBN cylinder prepared as in Preparation Example 1 was machined to form a friction stir welding tool. The friction stir welding tool was analyzed using X-ray diffraction. The X-ray diffraction results of the as-formed friction stir welding tool are shown in FIG. 5. As can be seen in the X-ray diffraction spectrum of FIG. 5, the as-formed friction stir welding tool included PCBN including cBN, AlN and AlB₂ in amounts of 79.2 wt %, 16.7 wt % and 4.1 wt %, respectively, based on the total weight of the PCBN.

### Comparative Example 2

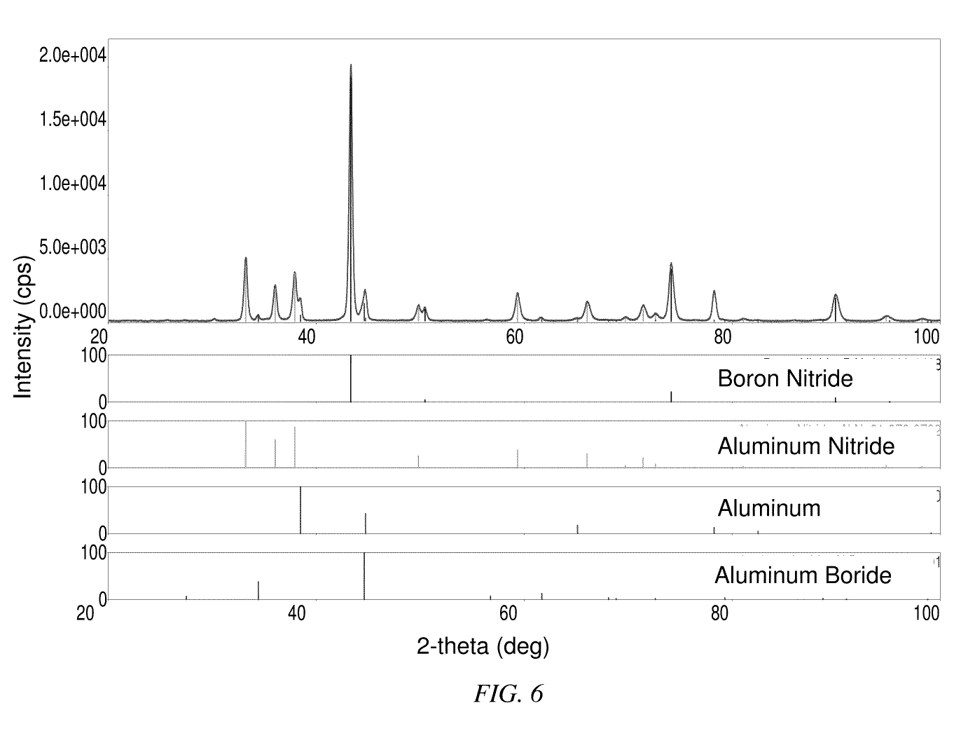

A PCBN cylinder prepared as in Preparation Example 1 was machined to form a friction stir welding tool, which was then used to friction stir weld along 8 meters of linear footage of 304 stainless steel having a thickness of 0.25 inch. After friction stir welding, the used friction stir welding tool was analyzed using X-ray diffraction. The X-ray diffraction results of the used friction stir welding tool are shown in FIG. 6. As can be seen in the X-ray diffraction spectrum of FIG. 6, the used friction stir welding tool included PCBN including cBN, AlN, AlB₂ and aluminum in amounts of 78.2 wt %, 17.3 wt %, 3.4 wt % and 1.1 wt %, respectively, based on the total weight of the PCBN. As can be seen in the X-ray diffraction results shown in FIGS. 5 and 6, using the friction stir welding tool for friction stir welding caused a portion of the AlB₂ to decompose to Al.

### Comparative Example 3

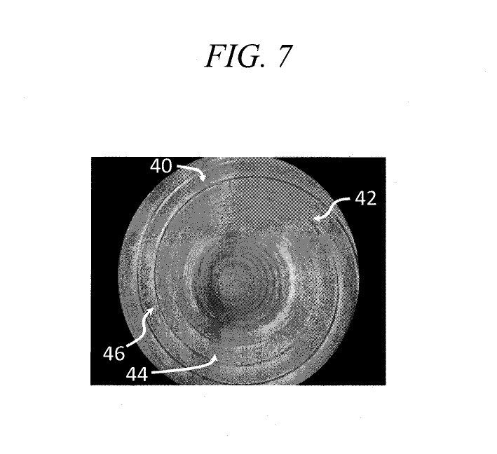

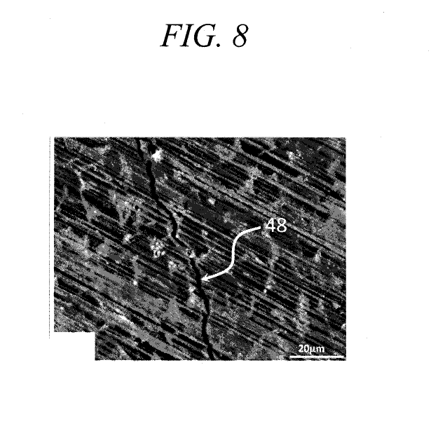

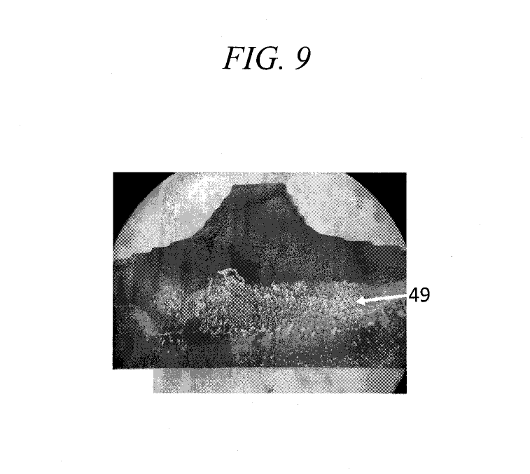

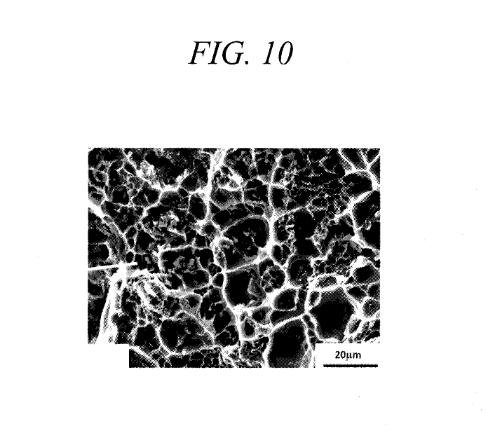

A PCBN cylinder prepared as in Preparation Example 1 was machined to form a friction stir welding tool, which was then used to friction stir weld along a few meters of high chrome D2 steel having a thickness of 0.25 inches. FIGS. 7 to 10 are photographs showing cracking in the friction stir welding tool. In FIG. 7, fine cracks 40, 42, 44 and 46 in the shoulder of the friction stir welding tool are indicated with arrows. FIG. 8 is a scanning electron microscope (SEM) image showing an intergranular-dominated crack 48 on the shoulder of the tool. FIG. 9 shows a white metallic deposit 49 on a fracture-opened surface of the PCBN. FIG. 10 is an SEM photograph of the fracture-opened surface of FIG. 9. As can be seen in FIG. 10, fractography reveals that the fracture-opened surface is rich in aluminum and exhibits dimples associated with ductile metals such as aluminum.

### Comparative Example 4

A PCBN cylinder was prepared as in Preparation Example 1 and was machined into multiple transverse rupture strength (TRS or flexural strength) bars. The TRS values were was measured at 25° C. according to ASTM C1161, which was scaled down to accommodate small PCBN bars having a width of 2 to 3 mm, a thickness of 2 to 3 mm, and a span less than 8.25 mm.

### Example 1

A PCBN cylinder prepared as in Preparation Example 1 was machined into multiple TRS bars and the TRS values were measured according to ASTM C1161, which was scaled down as described with respect to Comparative Example 4, while at least a portion of the PCBN bar was being heated in a furnace at a temperature of 900° C.

### Example 2

A PCBN cylinder prepared as in Preparation Example 1 was machined into multiple TRS bars and the TRS values were measured according to ASTM, which was scaled down as described with respect to Comparative Example 4, while at least a portion of the PCBN bar was being heated in a furnace at a temperature of 1000° C.

### Example 3

A PCBN cylinder prepared as in Preparation Example 1 was machined into multiple TRS bars and the TRS values were measured according to ASTM C1161, which was scaled down as described with respect to Comparative Example 4, while at least a portion of the PCBN bar was being heated in a furnace at a temperature of 1100° C.

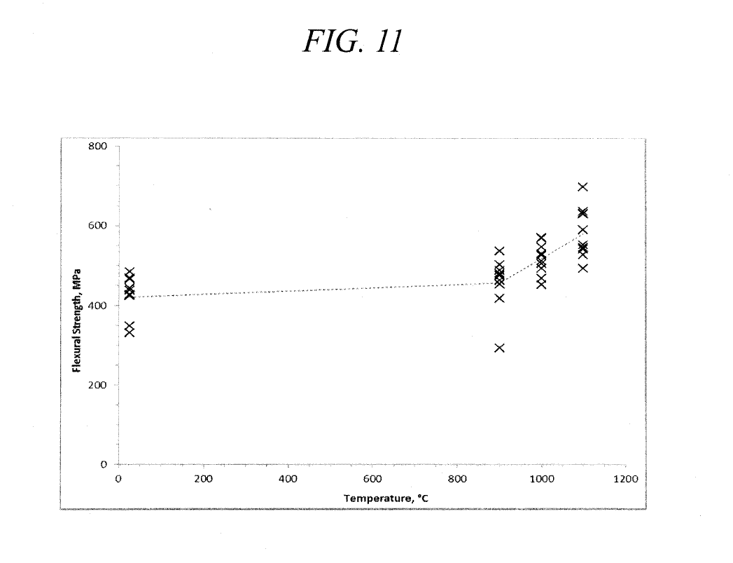

For each of Comparative Example 4 and Examples 1 to 3, 10 measurements were made at each temperature using 10 PCBN bars, the results of which are shown in FIG. 11. Comparative Example 4 and Examples 1 to 3 demonstrated a mean TRS (MPa), standard deviation (MPa), and % change relative to the TRS at 25° C. as shown in Table 1. The % change shows the change relative to the mean TRS measured at 25° C. As can be seen in Table 1, as compared to the mean TRS measured at 25° C., a 14% increase in strength was observed at 900° C. (Example 1), a 28% increase in strength was observed at 1000° C. (Example 2), and a 44% increase in strength was observed at 1100° C. (Example 3).

TABLE 1

| | Comparative | | | |
|---|---|---|---|---|
| | Example 4 | Example 1 | Example 2 | Example 3 |
| Temperature (° C.) | 25 | 900 | 1000 | 1100 |
| Mean TRS (MPa) | 420.7 | 456.2 | 518.1 | 579.6 |
| Standard Deviation of | 49.6 | 65.7 | 39.4 | 63.2 |
| TRS (MPa) | | | | |
| % Change Relative to | 100.0% | 108% | 123% | 138% |
| TRS at 25° C. | | | | |

### Example 4

Unstressed portions of PCBN bars (a portion of the bar that was not subjected to TRS testing) that were heated at a temperature 900° C. as in Example 1 were cooled down and the TRS values of the PCBN bars were tested again according to ASTM C1161, which was scaled down as described with respect to Comparative Example 4, at 25° C.

### Example 5

Unstressed portions of PCBN bars (a portion of the bar that was not subjected to TRS testing) that were heated at a temperature 1000° C. as in Example 2 were cooled down and the TRS values of the PCBN bars were tested again according to ASTM C1161, which was scaled down as described with respect to Comparative Example 4, at 25° C.

### Example 6

Unstressed portions of PCBN bars (a portion of the bar that was not subjected to TRS testing) that were heated at a temperature 1100° C. as in Example 3 were cooled down and the TRS values of the PCBN bars were tested again according to ASTM C1161, which was scaled down as described with respect to Comparative Example 4, at 25° C.

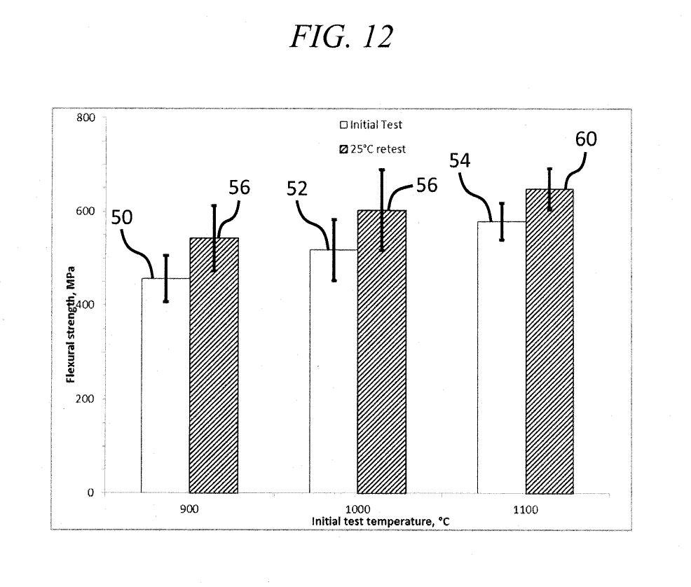

In FIG. 12, the results of the TRS test at 900° C. (Example 1), 1000° C. (Example 2), and 1100° C. (Example 3) are represented by the unshaded bars (the initial test) 50, 52 and 54, respectively, and the results of the TRS test after the bar had been cooled from a temperature of 900° C., 1000° C., or 1100° C. to 25° C. (Examples 4, 5, and 6, respectively) are represented by the shaded bars (the 25° C. re-test) 56, 58 and 60, respectively. One standard deviation for each measurement is also shown. As can be seen in FIG. 12, after being heated at 900° C., 1000° C., or 1100° C., the TRS observed at 25° C. (Examples 4, 5, and 6, respectively) was higher than that originally observed at 900° C., 1000° C., or 1100° C. (Examples 1, 2, and 3, respectively). Thus, instead of exhibiting a strength degradation with high temperature heat-treating (and subsequent cooling), the increased TRS observed at high temperature remained, and even increased, after cooling the PCBN bars to a temperature of 25° C. As such, the heat-treated PCBN bars did not exhibit strength degradation with high temperature heat-treating as a result of damage, and instead exhibited an increase in strength.

### Example 7

PCBN bars were prepared as in Preparation Example 1 and then at least a portion of each of the PCBN bars was heated in a furnace at a temperature of 1000° C. for five minutes. The PCBN bars were cooled to a temperature of 25° C. and the TRS values were measured according to ASTM C1161, which was scaled down as described with respect to Comparative Example 4, at a temperature of 25° C.

### Example 8

PCBN bars were prepared as in Preparation Example 1 and then at least a portion of each of the PCBN bars was heated under vacuum in a furnace at a temperature of 1000° C. for ninety minutes. The PCBN bars were cooled to a temperature of 25° C. and the TRS values were measured according to ASTM C1161, which was scaled down as described with respect to Comparative Example 4, at a temperature of 25° C.

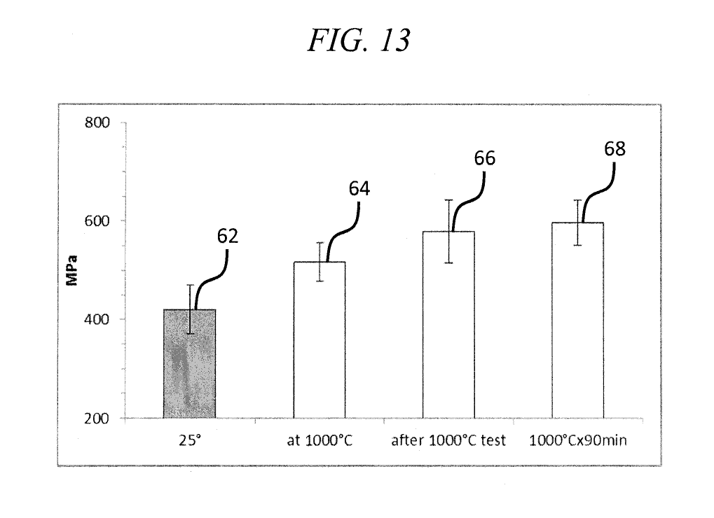

FIG. 13 shows the results of the TRS test at 25° C. (Comparative Example 4; represented by 62), at 1000° C. (Example 2; represented by 64), after heating at 1000° C. for five minutes and cooling to and testing the TRS at 25° C. (Example 7; represented by 66), and after heating at 1000° C. for 90 minutes under vacuum and cooling to and testing the TRS at 25° C. (Example 8; represented by 68). One standard deviation for each measurement is also shown. As can be seen in FIG. 13, the lowest TRS was observed at 25° C. (Comparative Example 4; represented by 62), and the TRS increased dramatically with testing at 1000° C. (Example 2; represented by 64). After heating at 1000° C., the TRS further increased upon cooling to and testing at 25° C. (Example 7; represented by 66). It can also be seen in FIG. 13 that the TRS observed after heating at 1000° C. for five minutes (Example 7; represented by 66) and the TRS observed after heating at 1000° C. for 90 minutes (Example 8; represented by 68) were substantially similar.

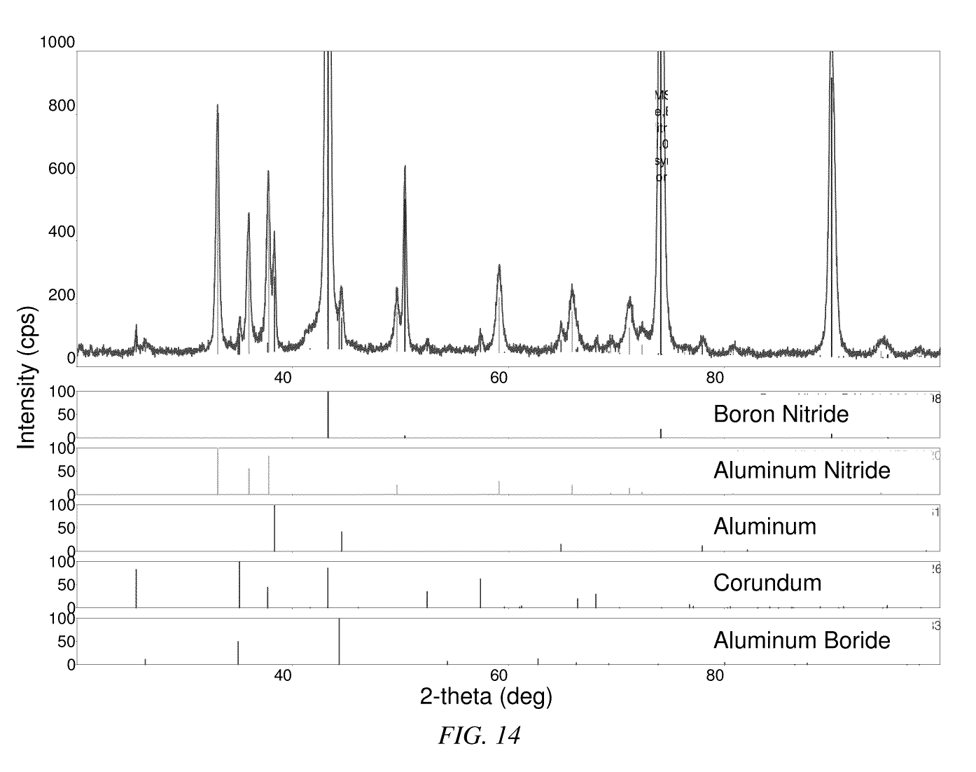

PCBN bars prepared and TRS tested as in Example 3 (at 1100° C.) were reassembled and the X-ray diffraction of the bars was measured. The results of the X-ray diffraction measurement after measuring the TRS are shown in FIG. 14. As can be seen in the X-ray diffraction spectrum of FIG. 14, after measuring the TRS at 1100° C. (Example 3), the PCBN bars prepared and TRS tested as in Example 3 included PCBN including cBN, AlN, AlB₂, aluminum and Al₂O₃ in amounts of 88.1 wt %, 6.6 wt %, 4.1 wt %, 0.5 wt %, and 0.7 wt %, respectively, based on the total weight of the PCBN, as well as a trace amount of AlB₁₂.

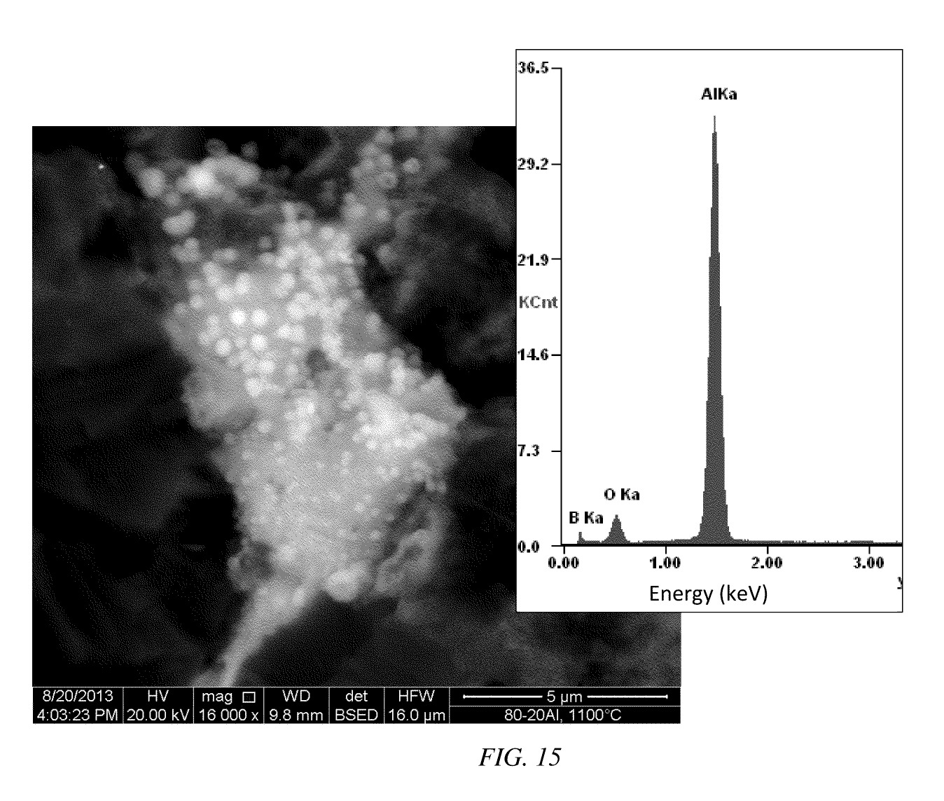

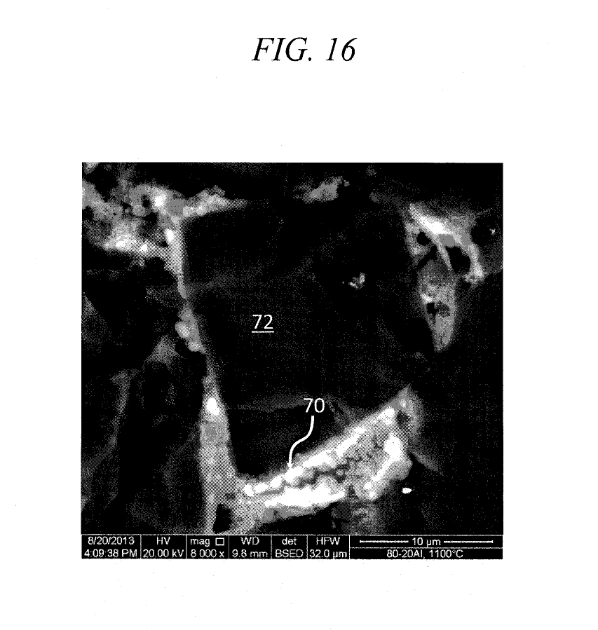

FIGS. 15 and 16 are scanning electron microscope (SEM) photographs of a fractured surface of a PCBN bar that was TRS tested at 1100° C. as in Example 3. The present inventors believe that the white spheres 70 in the SEM photographs of FIGS. 15 and 16 are aluminum metal that liquefied upon fracturing and then solidified according to Reaction Scheme 3: AlB₂→Al₍ₗ₎+AlB₁₂ (T≧980° C.) between the cBN grains 72. For example, FIG. 15 also includes the results of energy-dispersive X-ray spectroscopy (EDX), which indicate that the white spheres 70 shown in the SEM photograph of FIG. 15 primarily includes aluminum, and also includes boron and oxygen as minor components.

### Comparative Example 5

PCBN disks were prepared as in Preparation Example 1 and the mode I fracture toughness (K_{IC}) values were measured at 25° C. using a diametral compression method, which is described in more detail below.

### Example 9

PCBN disks were prepared as in Preparation Example 1 and the K_{IC} was measured according to the diametral compression method while at least a portion of the PCBN disk was being heated in a furnace at a temperature of 900° C.

### Example 10

PCBN disks were prepared as in Preparation Example 1 and the K_{IC} values were measured using the diametral compression method while at least a portion of the PCBN disk was being heated in a furnace at a temperature of 1100° C.

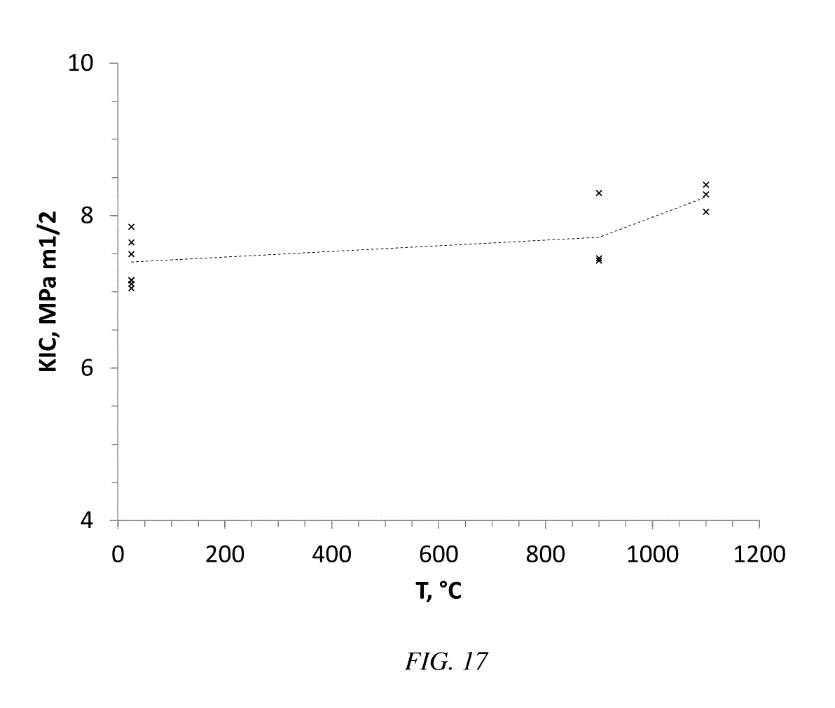

In Comparative Example 5 and Examples 9 and 10, at least 3 K_{IC} measurements were made at each temperature, the results of which are shown in FIG. 17. As can be seen in FIG. 17, at 25° C. (Comparative Example 5) the PCBN bar exhibited a mean K_{IC} of 7.39 MPa/m², at 900° C. (Example 9) the PCBN disks exhibited a mean K_{IC} of 7.66 MPa/m², and at 1100° C. (Example 10) the PCBN bar exhibited a K_{IC} of 8.19 MPa/m².

As can be seen in Examples 1 to 10, a phase-transformation-induced strengthening and toughening was observed after heat-treating PCBN. The phase transformation of AlB₂ to aluminum and AlB₁₂ at a temperature of greater than 980° C. is beneficial for strengthening and toughening PCBN including AlB₂. Further, carrying out a complete heating and cooling cycle (e.g., a cycle of heating at 1000° C. and cooling to 25° C.) is further beneficial.

### Example 11

PCBN cylinders were prepared by sintering a mixture including 90 vol % cubic boron nitride and 10 vol % aluminum metal powder, based on the total volume of the mixture, in a cubic press at a pressure of higher than 5 GPa and a temperature of 1350° C. for a time period of 15 minutes. The cBN had a bi-modal modal particle size distribution including 81 vol % of first particles in a range of 12 to 22 μm and 9 vol % of second particles in a range of 2 to 4 μm, based on the total volume of the cBN. The PCBN cylinder had a length of 1 inch (25.4 mm) and a diameter of 1 inch (25.4 mm).

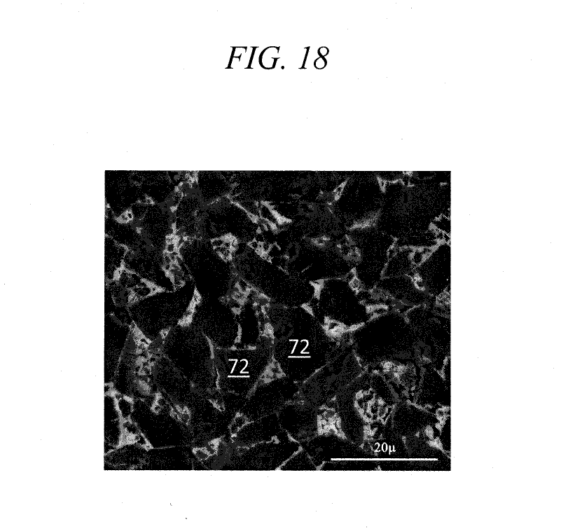

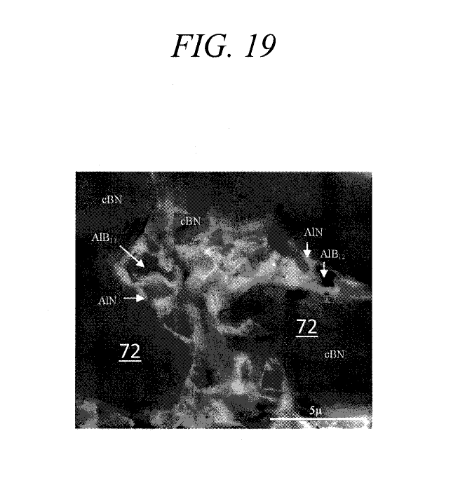

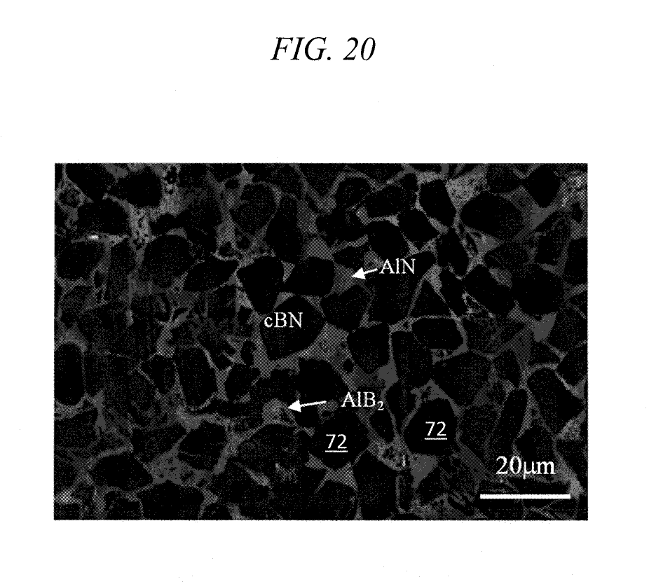

FIGS. 18 and 19 are SEM photographs of a PCBN cylinder prepared as in Example 11, while FIG. 20 is an SEM photograph of a PCBN cylinder prepared as in Preparation Example 1. As can be seen in FIGS. 18 to 20, the average distance between cBN grains 72 of Example 11 is substantially smaller than that of Preparation Example 1. Additionally, as can be seen in FIG. 19, the PCBN cylinder prepared as in Example 11 included AlN and AlB₁₂ between the cBN grains 72. On the other hand, as can be seen in FIG. 20, the PCBN cylinder prepared as in Preparation Example 1 included AlN and AlB₂ between the cBN grains 72.

### Example 12

A PCBN cylinder was prepared as in Example 11, except that the PCBN bar was prepared by sintering at 1350° C. for 2 minutes under 5 GPa of pressure.

### Example 13

A PCBN bar was prepared as in Example 11, except that the PCBN bar was prepared by sintering at 1245° C. for 15 minutes under 5 GPa of pressure.

### Example 14

A PCBN bar was prepared as in Example 11, except that the PCBN bar was prepared by sintering at 1420° C. for 30 minutes under 5 GPa of pressure.

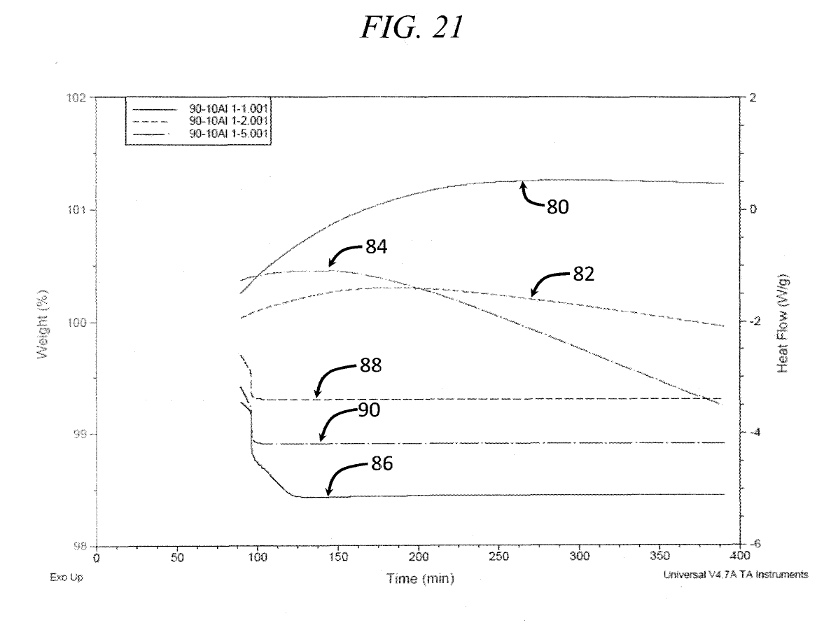

PCBN samples prepared as in Examples 12 to 14 were analyzed by thermogravimetric analysis (TGA) by heating each bar at 1000° C. for 300 minutes and analyzing the change in heat flow and mass of each PCBN sample. The TGA results for Examples 12 to 14 are shown in FIG. 21 in which the changes in weight % of Examples 12, 13 and 14 are represented by curved lines 80, 82 and 84, respectively, and the changes in heat flow of Examples 12, 13 and 14 are represented by curved lines 86, 88 and 90, respectively. As can be seen in FIG. 21, the PCBN samples prepared as in Examples 12 to 14 did not exhibit decomposition of AlB₂. Thus, TGA did not detect the presence of AlB₂ in the PCBN bars prepared as in Examples 12 to 14. As such, the PCBN samples prepared as in Examples 12 to 14 did not include AlB₂ in a detectable amount.

### Example 15

A PCBN cylinder prepared as in Example 11 was machined into multiple TRS bars and the TRS values were measured at 25° C. according to ASTM C1161, which was scaled down as described with respect to Comparative Example 4.

### Example 16

A PCBN cylinder prepared as in Example 11 was machined into multiple TRS bars and the TRS values were measured according to ASTM B528-12 C1161, which was scaled down as described with respect to Comparative Example 4, while at least a portion of the PCBN bar was being heated in a furnace at a temperature of 900° C.

### Example 17

A PCBN cylinder prepared as in Example 11 was machined into multiple TRS bars and the TRS values were measured according to ASTM C1161, which was scaled down as described with respect to Comparative Example 4, while at least a portion of the PCBN bar was being heated in a furnace at a temperature of 1100° C.

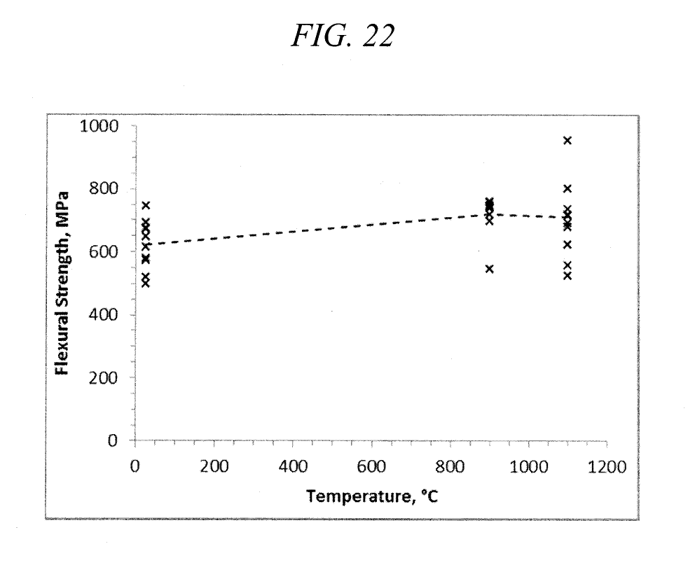

For each of Examples 15 to 17, 10 measurements were made at each temperature using ten PCBN bars, the results of which are shown in FIG. 22. Examples 15 to 17 demonstrated a mean TRS (MPa), and standard deviation (MPa) as shown in Table 2. As can be seen in Table 2, the PCBN bars prepared as in Examples 15 to 17 did not exhibit substantial strength degradation upon heating. Additionally, the PCBN bars prepared as in Examples 15 to 17 did not exhibit the substantial strength increase upon heating exhibited by the PCBN bars prepared as in Examples 1 to 3, which indicates that the PCBN bars prepared as in Examples 15 to 17 did not include a detectable amount of AlB₂ prior to heating that could be converted to AlB₁₂ by the heating.

TABLE 2

| | Example 15 | Example 16 | Example 17 |
|---|---|---|---|
| Temperature (° C.) | 900 | 1000 | 1100 |
| Mean TRS (MPa) | 622.9 | 720.2 | 712.3 |
| Standard Deviation of TRS | 73.3 | 63.5 | 114.6 |
| (MPa) | | | |

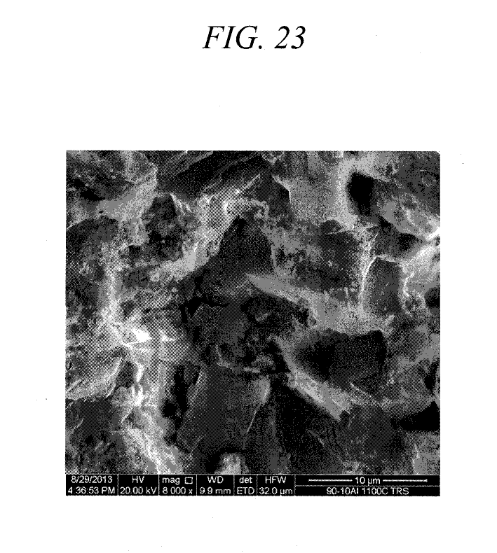

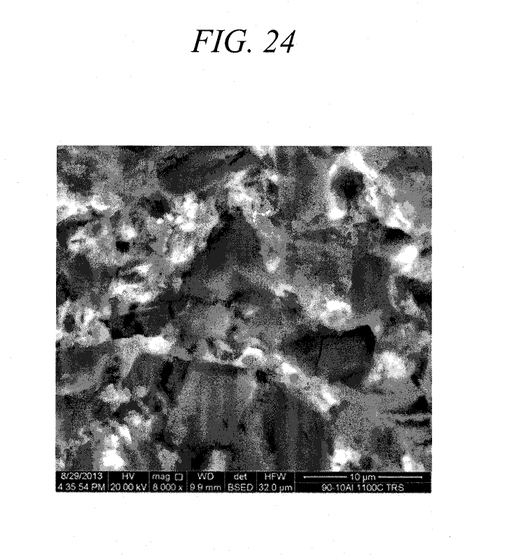

FIGS. 23 and 24 are SEM photographs of a fractured surface of a PCBN bar that was TRS tested at 1100° C. as in Example 17. FIG. 23 is an image produced from secondary electrons (an SE image), and FIG. 24 is an image produced from back-scattered electrons (a BSE image). FIGS. 23 and 24 do not show aluminum spheres that would indicate the formation of liquid aluminum from the decomposition of AlB₂. Thus, Example 17 did not include a detectable amount of AlB₂.

### Example 18

PCBN bars were prepared and TRS tested as in Example 16, and an unstressed portion of the PCBN bars (a portion of the bar that was not subjected to TRS testing) that was heated at a temperature 900° C. was cooled down and the TRS of the PCBN bar was tested again at 25° C.

### Example 19

A PCBN bar was prepared and tested as in Example 17, and an unstressed portion of the PCBN bar (a portion of the bar that was not subjected to TRS testing) that was heated at a temperature 1100° C. was cooled down and the TRS of the PCBN bar was tested again at 25° C.

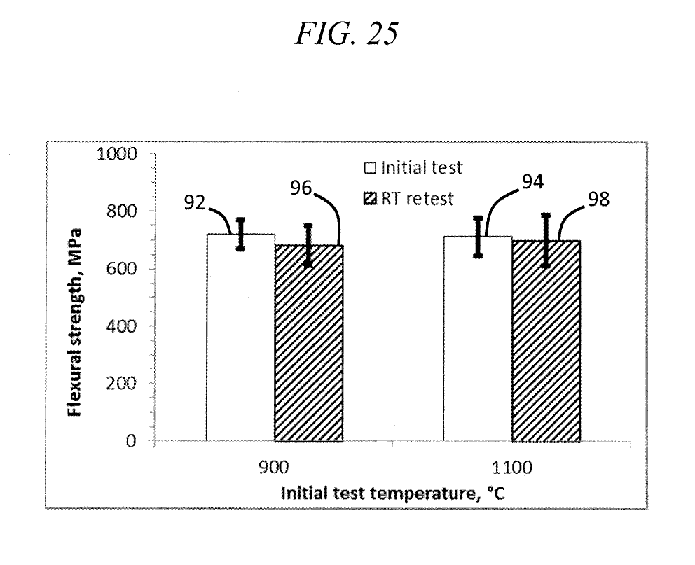

In FIG. 25, the results of the TRS test at 900° C. (Example 16), and 1100° C. (Example 17) are represented by the unshaded bars (the initial test) 92 and 94, respectively, and the results of the TRS test after the bar had been cooled from a temperature of 900° C. or 1100° C. to 25° C. (Examples 18 and 19, respectively) are represented by the shaded bars (the 25° C. re-test) 96 and 98, respectively. One standard deviation for each measurement is also shown. As can be seen in FIG. 25, after being heated to 900° C., the TRS observed at 25° C. (Example 18), was slightly less than that observed at 900° C. (Example 16). After being heated to 1100° C., the TRS observed at 25° C. (Example 19) was approximately the same as that observed at 1100° C. (Example 17). Thus, the PCBN bars prepared as in Examples 18 and 19 exhibited a similar or slight strength degradation with high temperature heat-treating and subsequent cooling.

### Example 20

PCBN disks were prepared as in Example 11 and the fracture toughness (K_{IC}) values were measured at 25° C. using the diametral compression method.

### Example 21

PCBN disks were prepared as in Example 11 and the K_{IC} was measured at 900° C. using the diametral compression method.

### Example 22

PCBN disks were prepared as in Example 11 and the K_{IC} was measured at 1100° C. using the diametral compression method.

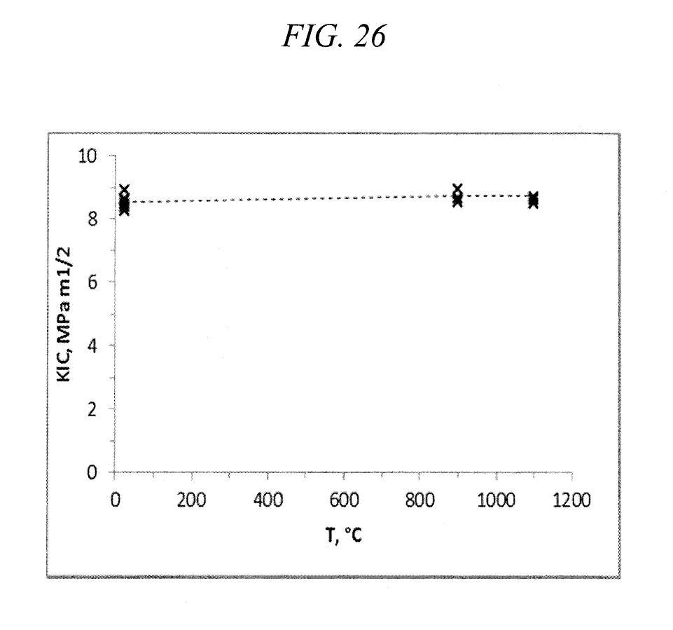

In Examples 20 to 22, at least 3 K_{IC} measurements were made at each temperature, the results of which are shown in FIG. 26. As can be seen in FIG. 26, at 25° C. (Example 20) the PCBN disks exhibited a mean K_{IC} of 8.53 MPa/m², at 900° C. (Example 21) the PCBN disks exhibited a mean K_{IC} of 8.72 MPa/m², and at 1100° C. (Example 22) the PCBN disks exhibited a K_{IC} of 8.61 MPa/m².

### Example 23

A PCBN cylinder prepared as in Example 11 was machined to form a friction stir welding tool, which was then used to friction stir weld 304 stainless steel having a thickness of ¼ inch (6.35 mm). The friction stir welding tool was able to friction stir weld 13.4 meters of linear footage of the stainless steel, which is further than the 8 meters of linear footage friction stir welded by the friction stir welding tool of Comparative Example 2. After friction stir welding, the used friction stir welding tool was fractured to inspect the interior (or bulk) of the used friction stir welding tool (e.g., to inspect the fractured surface).

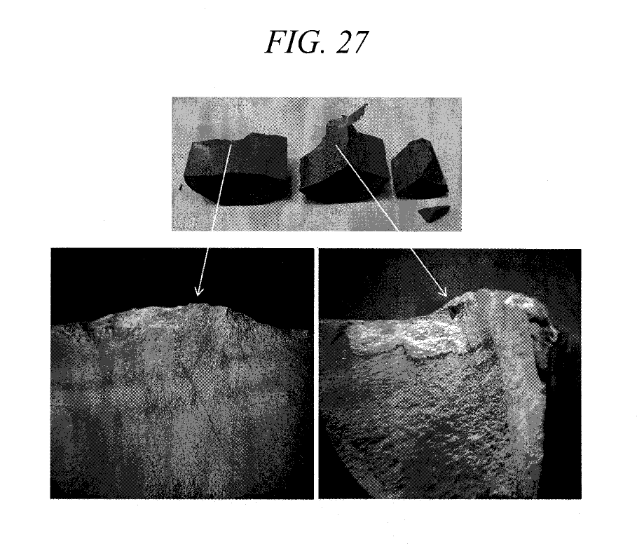

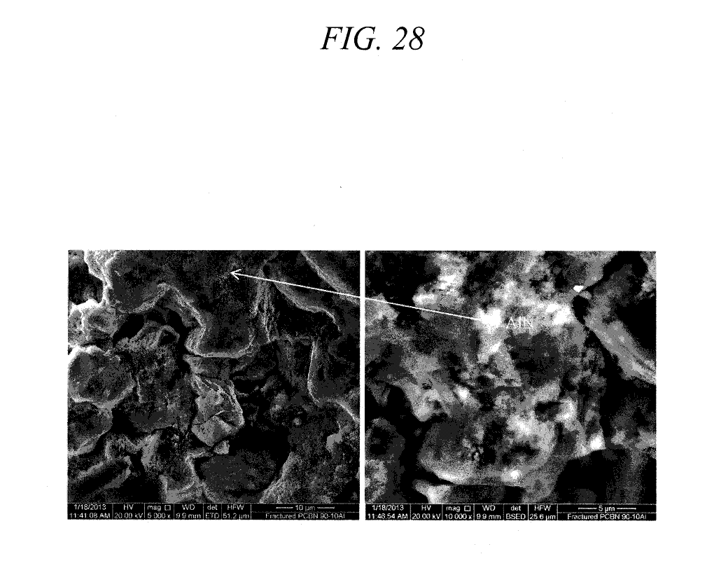

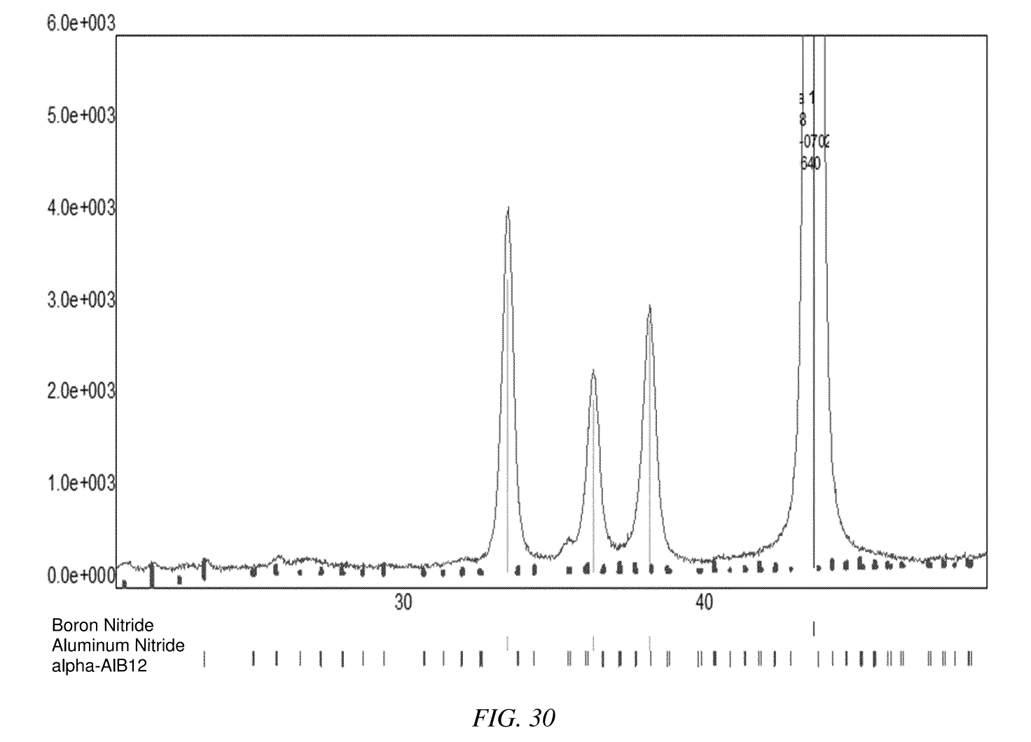

FIG. 27 is a series of photographs of the fractured friction stir welding tool, and FIG. 28 is a pair of SEM photographs of a fractured surface of the friction stir welding tool. While the photographs of FIG. 27 show some cracking of the shoulder of the friction stir welding tool, the SEM photographs of FIG. 28 do not show aluminum spheres that would indicate the formation of liquid aluminum from the decomposition of AlB₂, but the SEM photographs of FIG. 28 do show the presence of AlN. X-ray diffraction analysis was performed on the fractured surface of the friction stir welding tool, the results of which are shown in FIG. 30. From the X-ray diffraction analysis, the fractured surface of the friction stir welding tool prepared as in Example 23 was determined to include cBN, AlN, and AlB₁₂ in amounts of 79.3 wt %, 11.3 wt % and 9.4 wt %, respectively, based on the total weight of the PCBN. Thus, the friction stir welding tool prepared as in Example 23 did not include a detectable amount of AlB₂, and did not exhibit a phase transformation, even after friction stir welding processing.

### Example 24

A PCBN cylinder was prepared as in Example 11 and then at least a portion of the PCBN bar was heated under vacuum in a furnace at a temperature of 1000° C. for ninety minutes. The PCBN bar was then cooled to 25° C.

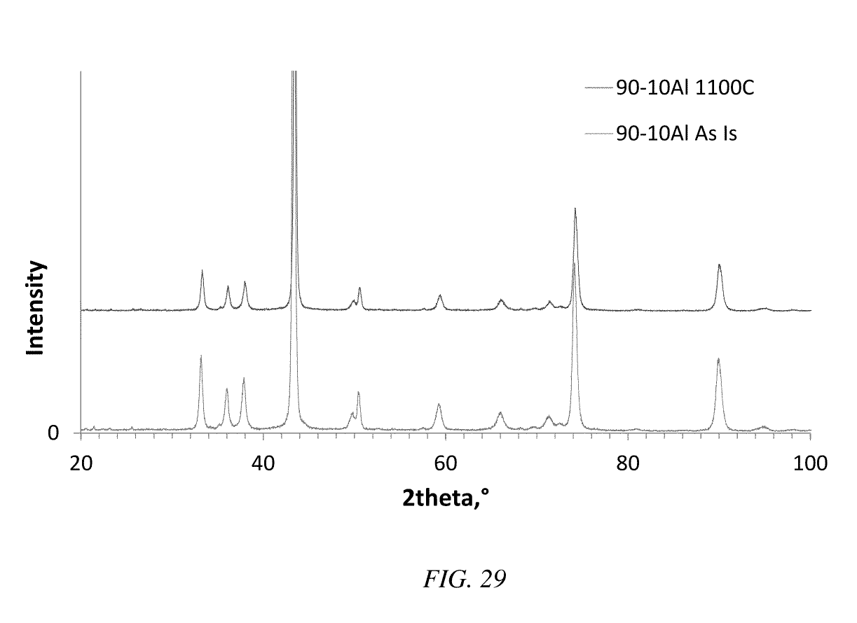

The X-ray diffraction of each of PCBN bars prepared as in Example 11, PCBN bars prepared and TRS tested at 1100° C. as in Example 17, and PCBN bars prepared as in Example 24 were measured. The results of the X-ray diffraction of the PCBN bars prepared as in Examples 11 and 17 are shown in FIG. 29. As can be seen in the X-ray diffraction spectra of FIG. 29, the PCBN bar prepared as in Example 11 included PCBN including cBN, AlN, and AlB₁₂ in amounts of 88.9 wt %, 8.1 wt % and 3.0 wt %, respectively, based on the total weight of the PCBN, and the PCBN prepared and TRS tested at 1100° C. as in Example 17 included PCBN including cBN, AlN, and AlB₁₂ in amounts of 80.4 wt %, 10.7 wt % and 8.9 wt %, respectively, based on the total weight of the PCBN. The X-ray diffraction analysis of the PCBN bar prepared as in Example 24 indicated the presence of trace amounts of AlB₁₂, but no AlB₂ was detected in the PCBN bar. Thus, the PCBN prepared as in Examples 11, 17 and 24 included AlB₁₂, but did not include a detectable amount of AlB₂, and did not exhibit a phase transformation after heat-treating.

As can be seen in Examples 11 to 24, PCBN prepared from a mixture including 90 vol % cBN and 10 vol % aluminum metal powder, based on the total volume of the mixture, where the cBN had a bi-modal modal particle size distribution including 81 vol % of first particles in a range of 12 to 22 μm and 9 vol % of second particles in a range of 2 to 4 μm, based on the total volume of the cBN, exhibited high strength and toughness, and the presence of AlB₂ in the PCBN was not detected.

### Diametral Compression Method

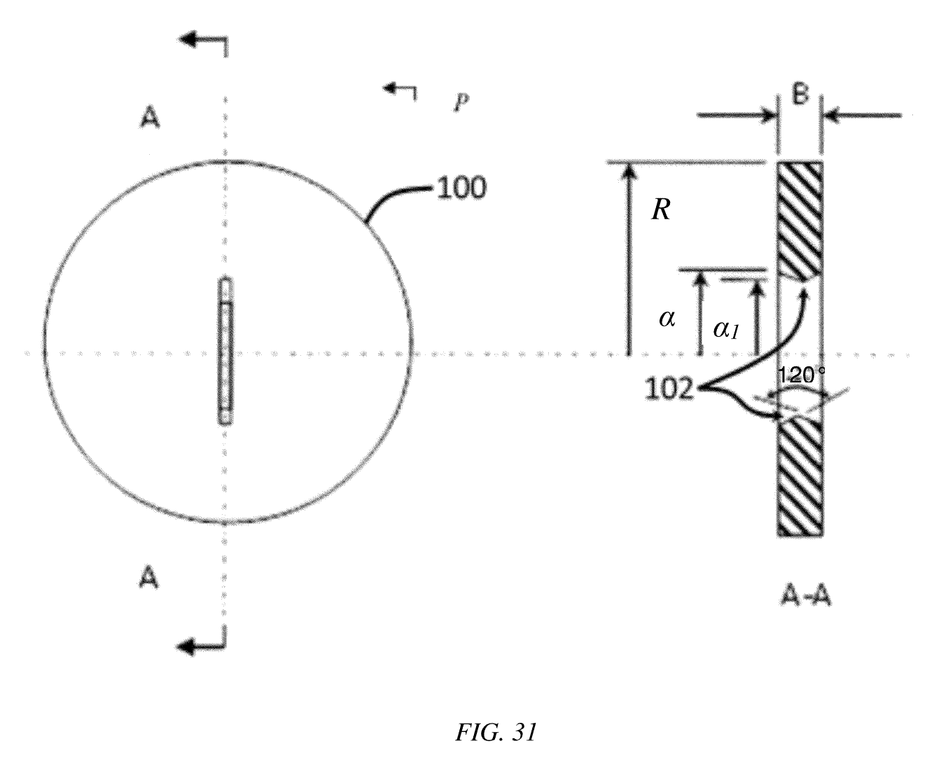

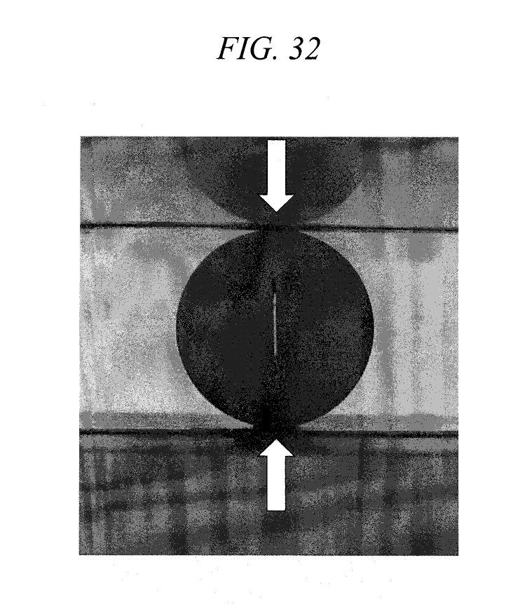

As described above, the plain strain fracture toughness, K_{IC}, was measured using a diametral compression method, which uses a diametral disk 100 having a center crack. According to the diametral compression method, to concentrate crack nucleation in a tip of an opening and in a planar propagation mode, a chevron notch 102 at each end of a slot can be implemented as shown in FIG. 31. The disk was loaded with a diametral compression force perpendicular to the center crack and K_{IC} can be calculated using equation:

$${K}_{I} = \frac{P}{{( π R )}^{1 / 2} B} Y$$

where P is the diametral compression load applied to the disk, R is the radius of the disk, B is the thickness of the disk, and Y is a dimensional parameter. When crack length a>a₁ (where a is the actual crack that is formed beyond a₁) then: Y=α^{1/2}N₁(α) where N₁(α)=0.991+0.141α+0.863α²+0.886α³. In case of pure mode I, N₁ (α) is a function only of the relative crack length α=a/R. FIG. 32 is a photograph of a disk undergoing a fracture toughness test according to the diametral compression method. The arrows in FIG. 32 indicate the direction of the diametral compression force applied to the disk.

Although only a few embodiments have been described in detail above, those skilled in the art will readily appreciate that many modifications are possible in the embodiments without materially departing from the subject matter of this disclosure. Accordingly, all such modifications are intended to be included within the scope of this disclosure. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of applicant not to invoke 35 U.S.C. §112(f) for any limitations of the claims herein, except for those in which the claim expressly uses the words “means for” together with an associated function. Throughout the text and claims, use of the word “about” reflects the penumbra of variation associated with measurement, significant figures, and interchangeability, all as understood by a person having ordinary skill in the art to which this disclosure pertains. Additionally, throughout this disclosure and the accompanying claims, it is understood that even those ranges that may not use the term “about” to describe the high and low values are also implicitly modified by that term, unless otherwise specified.

What is claimed is:

1. Polycrystalline cubic boron nitride comprising:
cubic boron nitride grains; and
AlB₁₂ between the cubic boron nitride grains.

2. The polycrystalline cubic boron nitride of claim 1, wherein the AlB₁₂ is present in the polycrystalline cubic boron nitride in an amount of 0.5 wt % to 10 wt %, based on the total weight of the polycrystalline cubic boron nitride.

3. The polycrystalline cubic boron nitride of claim 1, further comprising AlB₂, wherein the wt % of AlB₁₂ is greater than the wt % of AlB₂.

4. The polycrystalline cubic boron nitride of claim 3, wherein the AlB₂ is present in the polycrystalline cubic boron nitride in an amount greater than 0 wt % and less than 10 wt %, based on the total weight of the polycrystalline cubic boron nitride.

5. The polycrystalline cubic boron nitride of claim 1, wherein the polycrystalline cubic boron nitride is a heat-treated polycrystalline cubic boron nitride.

6. The polycrystalline cubic boron nitride of claim 1, wherein the polycrystalline cubic boron nitride is sintered from a mixture including cubic boron nitride and aluminum metal powder, the mixture comprising the cubic boron nitride in an amount of 80 vol % to 95 vol % and the aluminum metal powder in an amount of 5 vol % to 20 vol %, based on the total volume of the mixture.

7. A method of manufacturing heat-treated polycrystalline cubic boron nitride, the method comprising:
sintering a mixture comprising cubic boron nitride and aluminum metal powder to form polycrystalline cubic boron nitride; and
heat-treating the polycrystalline cubic boron nitride to form the heat-treated polycrystalline cubic boron nitride.

8. The method of claim 7, wherein the heat-treating is performed at a temperature of 900° C. to 1200° C.

9. The method of claim 7, wherein the heat-treating is performed for a time period of 5 minutes to 120 minutes.

10. The method of claim 7, wherein the mixture comprises the cubic boron nitride in an amount of 80 vol % to 95 vol % and the aluminum metal powder in an amount of 5 vol % to 20 vol %, based on the total volume of the mixture.

11. The method of claim 7, wherein the heat-treating comprises heating the polycrystalline cubic boron nitride with a heating element.

12. The method of claim 7, wherein the heat-treating is performed at temperature and for a time period sufficient to produce a heat-treated polycrystalline cubic boron nitride comprising a wt % of AlB₁₂ greater than a wt % AlB₂, based on the total weight of the polycrystalline cubic boron nitride.

13. The method of claim 7, further comprising:
machining the polycrystalline cubic boron nitride to form an article.

14. The method of claim 7, further comprising:
machining the heat-treated polycrystalline boron nitride to form an article.

15. A method of manufacturing polycrystalline cubic boron nitride, the method comprising:
sintering a mixture comprising cubic boron nitride and aluminum metal powder, the mixture comprising the cubic boron nitride in an amount of 85 vol % to 95 vol % and the aluminum metal powder in an amount of 5 vol % to 15 vol %, based on the total volume of the mixture.
